(19) United States
(12) Patent Application Publication
(10) Pub. No.: US 2005/0091917 A1
(43) Pub. Date: May 5, 2005

(54) Process for arranging cut flowers and floral arrangement apparatus

(76) Inventor: Michelle Brennan, Ontario (CA)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 10/492,313

(22) PCT Filed: Jun. 5, 2003
(86) PCT No.: PCT/CA03/00845

(51) Int. Cl. A01G 5/00

(52) U.S. Cl. 47/41.01

(57) ABSTRACT

A process for arranging flowers (22) is disclosed and comprises the step of providing apparatus (20) including a holder (28). The holder (28) includes a clamp (32) for each flower (22) and associated therewith in use, each clamp (32) being adapted to permit its associated flower (22) to be positioned at a display position relative thereto, and to grip around said flower (22) at a location proximate the junction of its blossom portion (24) and stem portion (26) when said flower (22) is so positioned. The apparatus (20) also includes a body (30) connecting the clamps (32) to one another such that, with each flower (22) disposed at its display position, the blossoms (24) screen said holder (28) in it least top plan view, the holder (28) being sufficiently light-weight such that it is supported with respect to the flowers (22) by the clamps (32) in use. The process further comprises the step of positioning each flower (22) at its display position relative to the clamp (32) with which it is associated.

### FIELD OF THE INVENTION

The present invention relates to the field of floral arrangements, and specifically, to a process for arranging cut flowers, and a floral arrangement apparatus adapted for use in such process.

### BACKGROUND OF THE INVENTION

Cut flowers are widely utilized for decoration, and it is commonplace for floral designers to arrange a bouquet of cut flowers and greenery, in a pleasing juxtaposition of colour, size, shape and flower type, with great care being taken to place each cut flower and piece of greenery into a position that maximizes beauty as part of the overall display. Such arrangements are often created in florist shops, and sold with vases therefor. Alternatively, the designer-may travel to the locale where the arrangement is needed, and create it onsite, in a vase or container of the customer.

To help prevent arrangements from shifting, a variety of processes for retaining cut flowers and greenery have been developed.

One widely utilized process employs open cell foams, which are packed within vases, and into and through which the stems of cut flowers and greenery can be forced and thereby secured.

It is also known to fit rigid grid structures within or onto vases, which define regular openings into which stems of cut flowers and greenery may be seated.

As yet another process, it is known to apply strips of floral tape to the open top of a vase, to form a grid or series of compartments, into which cut flowers and greenery may be seated.

The foregoing methods are known to be able to ameliorate the problem of shifting container-mounted floral arrangements, and indeed, quite ably so in the context of fulsome arrangements, wherein the abundance of flora is sufficient to conceal the tape, grid or foam, and wherein the flora is sufficiently tightly-packed to be self-supporting, even in the context of specimens whose height significantly exceeds that of the container therefor.

However, in more minimalist arrangements, the methods of the prior art can suffer.

For example, in relatively spare arrangements, the flowers can be spaced apart sufficiently to permit the unsightly tape, grid or foam to be visible to admirers of the arrangement.

Further, in relatively spare arrangements, wherein the height of the arrangement significantly exceeds that of the container, the flowers are prone to movement relative to one another, by virtue of their great unsupported length.

Additionally, grids and foams can suffer from poor aesthetics when used in association with transparent containers, as can tape, in arrangements wherein the open top of the container is not obscured.

### SUMMARY OF THE INVENTION

It is an object of the present invention to provide a process for retaining a floral arrangement that is suitable for use in association with containers including transparent vessels; that is adapted for use in arrangements wherein the height of the cut flowers significantly exceeds that of the container therefor; and that does not require an abundance of flowers for utility.

This object, amongst others, is obtained by the present invention, a process for arranging a plurality of cut flowers, each having a blossom portion and a stem portion extending from the blossom portion, and a floral arrangement apparatus for use with said plurality of cut flowers in said process.

The process comprises the step of providing said floral arrangement apparatus which, in use, as described fully below, provides a floral arrangement which: may be placed in a vase or container for display; may be used in the manner of a bouquet; and may be readily transported, without a vase, thereby to facilitate the retail sale of containerless floral arrangements.

The floral arrangement apparatus comprises a flower holder.

The flower holder includes a body member and a plurality of clamp means associated, in use, one with each of said flowers.

Each clamp means is adapted to permit its associated flower to be positioned at a display position relative thereto, and to grip around said flower at a location thereon proximate the junction of its blossom portion and stem portion when said flower is disposed at its display position.

The body member is connected to said clamp means to position same in spaced-apart, substantially-fixed relation to one another such that, in use, with each flower disposed at its display position, the blossom portions of said flowers substantially screen said flower holder in at least top plan view.

The flower holder is sufficiently light-weight such that, with each flower disposed at its display position in use, the mass of the flower holder is supported with respect to the flowers by the clamp means.

The process further comprises the step of positioning each of said flowers at its display position relative to the clamp means with which it is associated in use.

According to another aspect of the invention, the flower holder is preferably sufficiently light-weight such that, with each flower disposed at its display position in use, the flower holder and the blossom portions are supported by the stem portions without substantial bending of the stem portions.

According to another aspect of the invention, each clamp means preferably comprises a close-fitting ring having an outer dimension at least as large as the stem portion of the flower with which said each clamp means is associated in use, and an inner dimension smaller than the girth of said flower at the location whereat it is gripped in use.

The ring is deformable, to permit the stem portion of said flower to be inserted therethrough and to permit the flower to be drawn to its display position, whereat the ring encircles the flower at the location whereat it is gripped in use, and is also resilient, so as to frictionally grip about said flower at said location in use.

According to another aspect of the invention, each ring is preferably segmented into a plurality of tabs, formed integrally with the body member.

According to another aspect of the invention, the tabs and the body member are preferably constructed from cardboard.

According to another aspect of the invention, in use, each clamp means preferably grips around the stem portion of the flower with which it is associated, proximate the junction of the blossom portion and stem portion of said flower.

According to yet another aspect of the invention, the flower holder is preferably substantially planar.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

In the accompanying drawings, which are for the purpose of illustration and description only, and are not intended as a definition of the limits of the invention:

FIG. 1 is a top plan view of a floral arrangement formed according to a preferred embodiment of the process of the present invention;

FIG. 2 is a side elevational view of the floral arrangement of FIG. 1;

FIG. 3 is a top plan view of a floral arrangement apparatus adapted for use in the process according to the preferred embodiment of the present invention;

FIG. 4 is a top plan view of a floral arrangement apparatus provided in a first alternate embodiment of the process of the present invention; and

FIG. 5 is a top plan view of a floral arrangement apparatus provided in a second alternate embodiment of the process of the present invention.

### DETAILED DESCRIPTION OF A PREFERRED EMBODIMENT

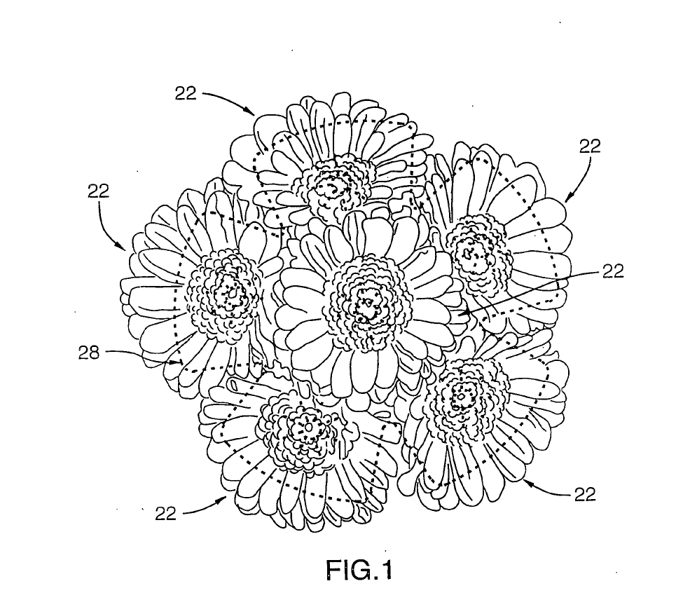

With general reference to. FIG. 1 through FIG. 5, a process according to a preferred embodiment of the present invention will be hereinafter described.

The inventive process is for arranging a plurality of cut flowers 22, each having a blossom portion 24 and a stem portion 26 extending from the blossom portion 24. For greater certainty, the flowers 22 do not form part of the invention.

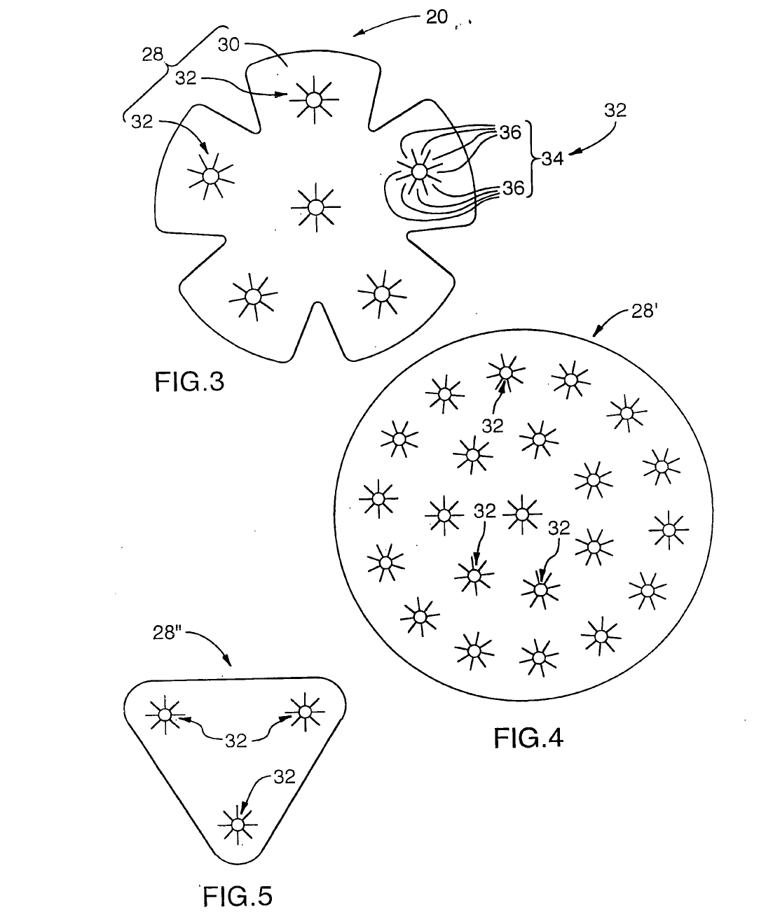

As an initial step in said process, a floral arrangement apparatus for use with said plurality of cut flowers is provided. A floral arrangement apparatus adapted for use in the preferred embodiment of the process is shown in FIG. 3 and designated with general reference numeral 20.

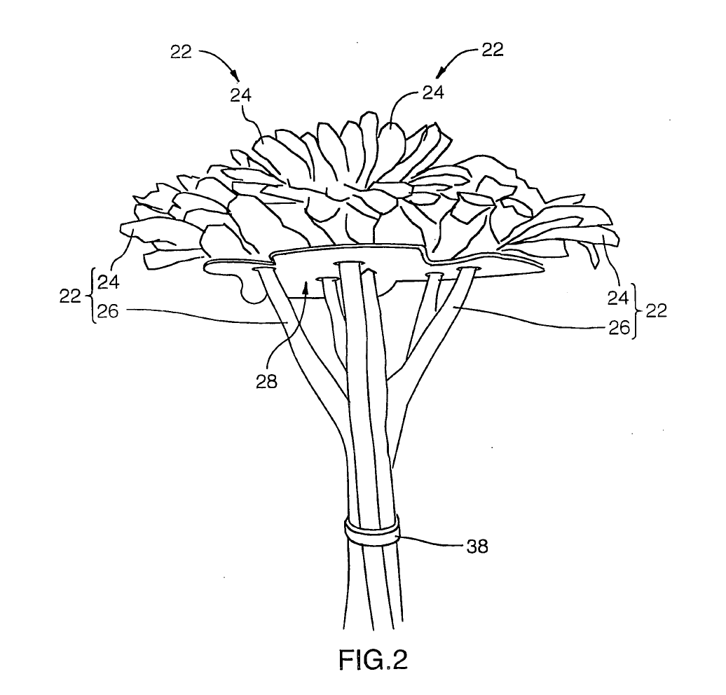

Said apparatus 20 will be seen to comprise a substantially planar flower holder 28 shaped in the manner of a notched disc and including a body member 30 and a plurality of clamp means 32 associated, in use, one with each of said flowers 22. Each clamp means 32 is preferably adapted to permit its associated cut flower 22 to be positioned at a display position relative thereto, as shown in FIG. 1 and FIG. 2, and to grip around the stem portion 26 of said cut flower 22, proximate the junction of its blossom portion 24 and stem portion 26, when said flower 22 is disposed at its display position. As seen in FIG. 3, each clamp means 32 preferably comprises a close-fitting cardboard ring 34 segmented into a plurality of tabs 36, namely, eight tabs 36, and has an outer dimension at least as large as the stem portion 26 of the flower 22 with which said each clamp means 32 is associated in use, and an inner dimension smaller than the girth of said flower 22 at the location whereat it is gripped in use.

The ring 34 is deformable, so as to permit the stem portion 26 of said flower 22 to be inserted therethrough and to permit the flower 22 to be drawn to its display position, whereat the ring 34 encircles the flower 22 at the location whereat it is gripped in use. The ring 34 is also resilient, so as to frictionally grip about said flower 22 at said location in use.

The body member 30 is preferably formed of cardboard, formed integrally with tabs 36, and thereby connected to the clamp means 32 to position same in spaced-apart, substantially fixed relation to one another such that, with each flower 22 disposed at its display position, the blossom portions 24 of said flowers 22 substantially screen said flower holder 28 in at least top plan view, as is well indicated by FIG. 1, wherein the outline of the flower holder 28 is shown in phantom outline.

The flower holder 28 is sufficiently light-weight such that, with each flower 22 disposed at its display position in use, the mass of the flower holder 28 is supported with respect to flowers 22 by the clamp means 32, and the flower holder 28 and the blossom portions 24 are supported by the stem portions 26 without substantial bending of the stem portions 26.

With the flower arrangement apparatus 20 so provided, each flower 22 need merely be positioned at its display position relative to the respective clamp means 32 with which it is associated in use, as previously shown in FIG. 1 and FIG. 2, to complete the inventive process.

The arrangement may be utilized in a variety of ways.

For example, the arrangement may be placed in a vase, and, as desired, surrounded by cut greenery, or other cut flowers, to conceal the flower arrangement apparatus 20 from viewpoints other than the top plan view of the flowers of the arrangement.

Alternatively, the flowers of the arrangement may be secured to one another, by an elastic band 38 or the like, as shown in FIG. 2, and used in the manner of a bouquet. Greenery may optionally be provided in this alternative, to surround the bouquet, as may be a sleeve of paper or similar material.

As another alternative which has proven unexpectedly advantageous, the flowers of the arrangement may be surrounded by greenery as desired, and packaged for transport, for example, using an elastic band, a paper cone or a combination thereof. This facilitates retail sales of containerless floral arrangements, such that consumers can obtain the look of a custom-designed floral arrangement without incurring the cost of a container, or the travel costs of a designer.

Various modifications to the process may be made without departing from the spirit and scope of the invention.

For example, whereas the flower holder of the preferred embodiment is constructed from cardboard, other materials, such as plastics materials, could be readily utilized.

As well, whereas the clamp means of the preferred embodiment comprise segmented rings, the rings could equally be formed in unitary fashion, out of deformable synthetic material or the like.

Additionally, it will also be evident that the flower holder can be provided in various shapes and sizes, and the size and spacing of the clamp means modified, to receive flowers of different shapes and sizes. For example, FIG. 4 shows a top plan view of a floral arrangement apparatus provided in a first alternate embodiment of the process of the present invention, wherein the body member 28′ provided is disc-shaped and has 22 clamps, but is otherwise structurally identical to that of the preferred embodiment; in contrast, FIG. 5 shows a top plan view of a floral arrangement apparatus according to a second alternate embodiment of the process of the present invention, wherein the body member 28″ is generally triangular and has 3 clamps, but is otherwise structurally identical to that of the preferred embodiment.

As well, whereas the clamp means of the flower holder shown grip around the stem portions of the flowers, proximate the junction of blossom portion and stem portion, the clamp means could equally be adapted to grip around the base of the blossom portions.

Further, whereas the flower holder of the preferred embodiment is substantially planar, it could readily be contoured, for example, in the manner of a dome, such that in use, the blossom portions of said flowers substantially screen said flower holder in, for example, side elevational view.

Yet further, whereas the clamp means of the preferred embodiment are substantially identical, the clamp means can be provided in different sizes, if desired, to receive flowers of different sizes.

Accordingly, it will be understood that the scope of the present invention is limited only by the accompanying claims, purposively construed.

1. A floral arrangement apparatus for use with a plurality of cut flowers, each having a blossom portion and a stem portion extending from the blossom portion, said apparatus comprising:
a flower holder including
a plurality of clamp means associated, in use, one with each of said flowers, each being adapted to permit its associated flower to be positioned at a display position relative thereto, and being adapted to grip around said flower at a location thereon proximate the junction of its blossom portion and stem portion when said flower is disposed at its display position;
a body member connected to said clamp means to position same in spaced-apart, substantially fixed relation to one another such that, in use, with each flower disposed at its display position, the blossom portions of said flowers substantially screen said flower holder in at least top plan view,
wherein the flower holder is sufficiently light-weight such that, with each flower disposed at its display position in use, the mass of the flower holder is supported with respect to the flowers by the clamp means.

2. Apparatus according to claim 1, wherein the flower holder is sufficiently light-weight such that, with each flower disposed at its display position in use, the flower holder and the blossom portions are supported by the stem portions without substantial bending of the stem portions.

3. Apparatus according to claim 2, wherein each clamp means comprises a close-fitting ring having an outer dimension at least as large as the stem portion of the flower with which said each clamp means is associated in use, and an inner dimension smaller than the girth of said flower at the location whereat it is gripped in use, said ring: being deformable, to permit the stem portion of said flower to be inserted therethrough and to permit the flower to be drawn to its display position, whereat the ring encircles the flower at the location whereat it is gripped in use; and being resilient, so as to frictionally grip about said flower at said location in use.

4. Apparatus according to claim 3, wherein each ring is segmented into a plurality of tabs, formed integrally with the body member.

5. Apparatus according to claim 4, wherein each ring is segmented into eight tabs.

6. Apparatus according to claim 4, wherein the tabs and the body member are constructed from cardboard.

7. Apparatus according to claim 4, wherein, in use, each clamp means grips around the stem portion of the flower with which it is associated, proximate the junction of the blossom portion and stem portion of said flower.

8. Apparatus according to claim 1, wherein all the clamp means are identical.

9. Apparatus according to claim 1, wherein the flower holder is substantially planar.

10. A process for arranging a plurality of cut flowers, each having a blossom portion and a stem portion extending from the blossom portion, said process comprising the steps of:
(a) providing a floral arrangement apparatus for use with said plurality of cut flowers, said apparatus comprising a flower holder including:
a plurality of clamp means associated, in use, one with each of said flowers, each being adapted to permit its associated flower to be positioned at a display position relative thereto, and being adapted to grip around said flower at a location thereon proximate the junction of its blossom portion and stem portion when said flower is disposed at its display position;
a body member connected to said clamp means to position same in spaced-apart, substantially fixed relation to one another such that, in use, with each flower disposed at its display position, the blossom portions of said flowers substantially screen said flower holder in at least top plan view,
wherein the flower holder is sufficiently light-weight such that, with each flower disposed at its display position in use, the mass of the flower holder is supported with respect to the flowers by the clamp means; and
(b) positioning each of said flowers at its display position relative to the clamp means with which it is associated in use.

11. A process according to claim 10, wherein the flower holder is sufficiently light-weight such that, with each flower disposed at its display position in use, the flower holder and the blossom portions are supported by the stem portions without substantial bending of the stem portions.

12. A process according to claim 11, wherein each clamp means comprises a close-fitting ring having an outer dimension at least as large as the stem portion of the flower with which said each clamp means is associated in use, and an inner dimension smaller than the girth of said flower at the location whereat it is gripped in use, said ring: being deformable, to permit the stem portion of said flower to be inserted therethrough and to permit the flower to be drawn to its display position, whereat the ring encircles the flower at the location whereat it is gripped in use; and being resilient, so as to frictionally grip about said flower at said location in use.

13. A process according to claim 12, wherein each ring is segmented into a plurality of tabs, formed integrally with the body member.

14. A process according to claim 13, wherein each ring is segmented into eight tabs.

15. A process according to claim 13, wherein the tabs and the body member are constructed from cardboard.

16. A process according to claim 15, wherein, in use, each clamp means grips around the stem portion of the flower with which it is associated, proximate the junction of the blossom portion and stem portion of said flower.

17. A process according to claim 10, wherein all the clamp means are identical.

18. A process according to claim 10, wherein the flower holder is substantially planar.
